(19) United States
(12) Patent Application Publication
(10) Pub. No.: US 2019/0156576 A1
(43) Pub. Date: May 23, 2019

(54) METHOD AND SYSTEM FOR CURATING, ACCESSING, AND DISPLAYING A PLURALITY OF DATA RECORDS PERTAINING TO PREMISES, AND A PLURALITY OF DEVICES INSTALLED IN THE PREMISES

(71) Applicant: Bernard Ndolo, Luxembourg (LU)

(72) Inventor: Bernard Ndolo, Luxembourg (LU)

(21) Appl. No.: 15/817,964

(22) Filed: Nov. 20, 2017

(51) Int. Cl. G06T 19/00; G06F 3/01; G06F 3/0484; G06F 17/30

(52) U.S. Cl. CPC G06T 19/006; G06F 3/017; G06T 2200/24; G06F 17/3028; G06F 3/0484

(57) ABSTRACT

Disclosed is a system and method for curating, accessing, and displaying a plurality of data records pertaining to premises, and a plurality of devices installed in the premises. The method includes the step of curating a plurality of data records pertaining to premises and a plurality of devices installed in the premises. The plurality of data records is curated during planning, construction, and installation phases. The method includes the step of storing the curated data records in a database. The method includes the step of accessing the stored data records corresponding to the premises and the devices through a computing unit on receiving an input command from a user or the stored data may automatically activate through a plurality of sensors configured to the computing unit. The method includes the step of displaying the accessed data on receiving a pointing gesture from the user through the computing unit either towards the premises, the devices installed in the premises, a plurality of elements within the premises such as a wall, ceilings, floors, doors etc. The computing unit comprises an augmented reality mechanism to display the curated data records through a plurality of pre-defined user-interface states.

### TECHNICAL FIELD

The present invention generally relates to a method and system for curating, accessing, and displaying a plurality of data records pertaining to premises, and a plurality of devices installed in the premises.

### BACKGROUND

Conventionally, a user depends on a blueprint, user manual, and documents to access and understand the data and information of constructed premises to be renovated (room, house, building etc.), and the devices (electrical cabling, plumbing networks, gas sensors, heating unit, ventilation, air conditioning units, lights, furniture etc.) installed in the premises.

The utilization of the blueprint, user manuals, and documents slow down the response times to critical events which can, in turn, lead to increased possibilities of incurring expensive repair costs. Delays in undertaking repairs and renovations of the premises and devices can lead to serious accidents in the event of an emergency such as an electrical fault, fire, water damage and etc. Furthermore, in case the device or service provider is unavailable, the user or owner has to waste a lot of time and money searching for an alternative service provider who in turn has to find/search for the original installation blueprints or information concerning the installed devices and smart sensors.

Additionally, there are many contractors and vendors that are involved in the construction of premises, therefore, when an installed device fails to operate as expected, or many at times are outdated, the users and premises owners have to locate the information pertaining to the contractors/vendors who worked on the project. Information about the installation dates and guarantee obligations of the various installed devices and systems are not easily and readily accessible, obtainable or many at times are outdated. The users are therefore faced with the challenges of sourcing new systems, devices and service providers which in turn leads to waste valuable resources of time and money.

There are various systems and methods that exist to solve the aforementioned problems. However, the existing systems and methods do not provide the premises owner/end user a unified platform and a software application that can be used to easily access curated data and information, view the curated data and information, offer control functions of the installed devices and systems and enable them to purchase goods and services relating to devices, smart sensors, installation and maintenance services. The existing systems and methods provide the premise owner/end user multiple or different platforms and software applications that are used to access data and information, view the data and information, control the various installed devices and systems and offer fragmented options to enable the purchase of goods and services. This lack of a unified platform and a software application, in turn, leads to a complex, slow, expensive and often frustrating user experience.

Therefore, there is a need for a unified system and method that can be used to easily access curated data and information, view the curated data and information, offer control functions of the installed devices and systems and enable them to purchase goods and services relating to devices, smart sensors, installation and maintenance services. Furthermore, there is a need for a system and method which can enable the user to add to or remove from the curated data and information of the installed devices and systems.

The disadvantages and limitations of traditional and conventional approaches will become apparent to the person skilled in the art through a comparison of the described system and method with some aspects of the present disclosure, as put forward in the remainder of the present application and with reference to the drawings.

### DISCUSSION OF RELATED ART

A system and method to provide an augmented reality image which combines a real-time, real view of an external element (e.g., a wall or a ceiling) in a real environment, overlaid with an image of a 3D digital model of internal elements such as pipes, conduits, wall studs etc. as they exist hidden behind the external element. By incorporating the AR (Augmented Reality) technology into land surveying, 3D laser scanning, and digital modelling processes, the 3D digital model of the internal elements is overlaid on the live view of the mobile device, aligned to the orientation and scale of the scene shown on the mobile device, as disclosed in US patent application 20140210856 A1 of Sean Finn, which is incorporated herein by reference. Further, a wearable augmented-reality system such as DAQRI Smart Helmet, being developed for use in industrial fabrication industries—especially the building and construction industry. Essentially, this smart helmet allows builders, engineers, and designers to take their BIM model to the construction site, wear it on their heads, and experience it as an immersive, full-scale 3D environment. Furthermore, Shapetrace has developed an augmented/mixed reality tools to help construction teams prevent errors and build right the first time. They compare the 3D construction plans (BIM) with the actual conditions using tablets. However, the patent and non-patent literature mentioned above do not explicitly discuss a unified system and method to access and display the curated data records and information pertaining to any premises, and devices installed in the premises. The existing arts are limited to only manufacturing plants and other industrial equipment. Additionally, the existing arts offer only one aspect of the AR (Augmented Reality) data viewing function and while utilizing CAD drawings to identify the devices. Further, the literature mentioned above also does not talk about a unified platform and a software application that enables the user to order the replacement or upgrade devices, including the possibility of purchasing maintenance and installation services for those devices.

### SUMMARY OF INVENTION

According to embodiments illustrated herein, there is provided a system which functions as a unified platform and a software application for curating, accessing, and displaying a plurality of data records pertaining to premises, and a plurality of devices installed in the premises. The platform and the software application also include the function of controlling the plurality of installed devices and systems and enabling the purchase of goods and services related to such devices and systems. The unified platform and the software application includes a processor, and a memory to store machine readable instructions that when executed by the processor, curate a plurality of data records pertaining to premises and a plurality of devices installed in the premises through a curation module. The plurality of data records and information is curated during a plurality of phases such as a planning phase of the premises, a construction phase of the premises, an installation phase of the devices in the premises. The processor is further configured to store the curated data records in a database. Then the processor is configured to access the stored data records corresponding to the premises and the devices through an access module by utilizing a computing unit on receiving an input command from a user or the stored data may automatically activate through a plurality of sensors configured to the computing unit.

Further, the processor is configured to display the accessed data through a display module on receiving a pointing gesture by the computing unit either towards at least one of the premises, the devices installed in the premises, a plurality of elements within the premises such as a wall, ceilings, floors, doors etc. The computing unit comprises an augmented reality mechanism to display the curated data records through a plurality of pre-defined user-interface states. In an aspect, the present unified platform and application enable the user to diagnose installed devices and purchase replacement devices and maintenance services of the installed devices.

As per the embodiments illustrated herein, there is provided a method for curating, accessing, and displaying a plurality of data records pertaining to premises, and a plurality of devices installed in the premises. The method includes the step of curating, by one or more processors, a plurality of data records pertaining to premises, and a plurality of devices installed in the premises. The plurality of data records is curated during a plurality of phases such as a planning phase of the premises, a construction phase of the premises, an installation phase of the devices in the premises. Then the method includes the step of storing, by one or more processors, the curated data records in a database. Further, the method includes the step of accessing, by one or more processors, the stored data records corresponding to the premises and the devices through a computing unit on receiving an input command from a user or the stored data may automatically activate through a plurality of sensors configured to the computing unit. Furthermore, the method includes the step of displaying, by one or more processors, the accessed data on receiving a pointing gesture from the user through the computing unit either towards the premises, or various elements within the premises such as wall, ceilings, floors, doors etc. or the devices installed in the premises. The computing unit comprises an augmented reality mechanism to display the curated data records through a plurality of pre-defined user-interface states.

Accordingly, one advantage of the present invention is that it provides a unified platform and an application that displays the installed infrastructure in the premise, provides a control over the devices, allows the end user to order/purchase replacement or upgrade devices, enables the user to order maintenance and installation of services, and ability to extract diagnostics information of the installed devices and systems.

Accordingly, one advantage of the present invention is that it provides a fast and easy access to the curated data records and information about the premises or the installed devices in the premises by using a single/one software application that has a user interface which automatically responds to the users pointing gestures, preferences and computing unit internal sensors.

Another advantage of the present invention is that it enables the user to add to or remove from the curated data and information of the premises and the installed devices.

Still another advantage of the present invention is that it provides a novel mechanism to automatically identify an installed device in the premises and to provide the curated data and diagnostics of that installed device.

Another advantage of the present invention is that it enables the user to purchase a replacement device or system, purchase installation, repair or maintenance services from approved or various suppliers and installation companies.

Still another advantage of the present invention is that it enables the user to control multiple functions of the different installed devices and systems in the premises.

Still another advantage of the present invention is that it provides the user with the installation date of the device, the installer's name, and contact details of the installer.

Still another advantage of the present invention is that it informs the user about the availability schedules of the various maintenance and installers contractors based on the geographical location of the user.

Still another advantage of the present invention is that it enables the user to rate the services provided by the various device suppliers, installers and maintenance providers.

Still another advantage of the present invention is that it provides a single/one software application that has a user interface which automatically responds to the users pointing gestures, preferences and computing unit internal sensors to gain access to all the above-mentioned advantages.

The aforementioned features and advantages of the present disclosure may be appreciated by reviewing the following description of the present disclosure, along with the accompanying figures wherein like reference numerals refer to like parts.

### BRIEF DESCRIPTION OF DRAWINGS

The appended drawings illustrate the embodiments of the system and method for curating, accessing, and displaying a plurality of data records information pertaining to premises, elements of the premises, and a plurality of devices installed in the premises of the present disclosure. Any person with ordinary skills in the art will appreciate that the illustrated element boundaries in the drawings represent an example of the boundaries. In an exemplary embodiment, one element may be designed as multiple elements, or multiple elements may be designed as one element. In an exemplary embodiment, an element shown as an internal component of one element may be implemented as an external component in another and vice versa. Furthermore, the elements may not be drawn to scale.

Various embodiments will hereinafter be described in accordance with the accompanying drawings, which have been provided to illustrate, not limit, the scope, wherein similar designations denote similar elements, and in which:

FIG. 1 illustrates the flowchart of the method for curating, accessing, and displaying a plurality of data records pertaining to premises, and a plurality of devices installed in the premises, in accordance with an embodiment.

FIG. 2 represents a block diagram of the present system for curating, accessing, and displaying a plurality of data records pertaining to premises, and a plurality of devices installed in the premises, in accordance with at least one embodiment;

FIG. 3 illustrates an exemplary view of a pointing gesture from the user through the computing unit towards the device (smart sensors) of the premises, in accordance with at least one embodiment;

FIG. 4 illustrates an augmented reality control state of the device such as a TV on receiving a pointing gesture from the user through the computing unit, in accordance with at least one embodiment;

FIG. 5 illustrates an augmented reality control state of the device such as a stereo system on receiving a pointing gesture from the user through the computing unit, in accordance with at least one embodiment;

FIG. 6 illustrates an exemplary view of a pointing gesture from the user through the computing unit towards the floor of the premises, in accordance with at least one embodiment;

FIG. 7 illustrates an exemplary view of a pointing gesture from the user through the computing unit towards the ceiling of the premises, in accordance with at least one embodiment;

FIG. 8 illustrates an exemplary view of a 360 degree pointing gesture from the user through the computing unit towards the wall of the premises or the devices installed in the premises, in accordance with at least one embodiment;

FIG. 9 illustrates an exemplary view of the user wearing a mixed reality headset, in accordance with at least one embodiment;

FIG. 10 illustrates an exemplary view of the user wearing a virtual reality headset, in accordance with at least one embodiment;

FIG. 11 illustrates an exemplary view of a pointing gesture from the user through the computing unit towards the lights installed in an office, in accordance with at least one embodiment;

FIG. 12 illustrates an exemplary view of a pointing gesture from the user through the computing unit towards a building, in accordance with at least one embodiment;

FIG. 13 illustrates a plurality of pre-defined user-interface states, in accordance with at least one embodiment;

FIG. 14 illustrates an exemplary view of a clock face/other image user-interface state and augmented reality user-interface state depicts plumbing and cabling networks, in accordance with at least one embodiment;

FIG. 15 illustrates an augmented reality control state and an exemplary view of a pointing gesture from the user through the computing unit to control an air-conditioning unit installed in the premises, in accordance with at least one embodiment; and

FIG. 16 illustrates an augmented reality control state and an exemplary view of a pointing gesture from the user through the computing unit to control a floor heating unit installed in the premises, in accordance with at least one embodiment.

### DETAILED DESCRIPTION

The present disclosure is best understood with reference to the detailed drawings and description set forth herein. Various embodiments have been discussed with reference to the drawings. However, the person skilled in the art will readily appreciate that the detailed descriptions provided herein with respect to the drawings are merely for explanatory purposes, as the systems and methods may extend beyond the described embodiments. For instance, the teachings presented and the needs of a particular application may yield multiple alternative and suitable approaches to implement the functionality of any detail described herein. Therefore, any approach may extend beyond certain implementation choices in the following embodiments.

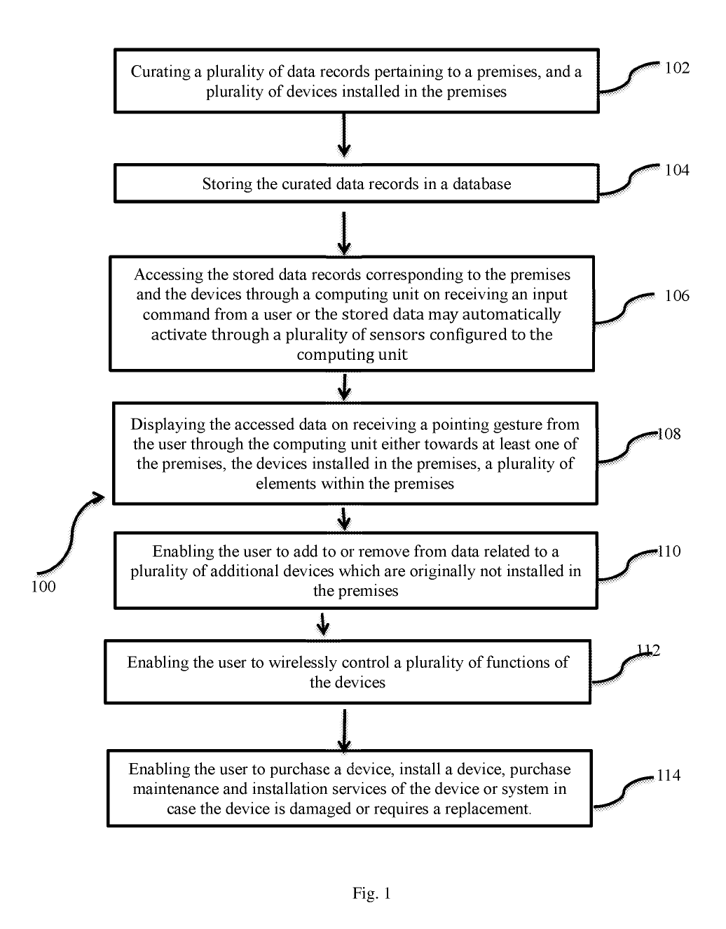

FIG. 1 illustrates the flowchart 100 of the method for curating, accessing, and displaying a plurality of data records pertaining to premises, and a plurality of devices installed in the premises, in accordance with an embodiment. The method initiates with the step 102 of curating, by one or more processors, a plurality of data records pertaining to premises, and a plurality of devices installed in the premises. In an embodiment, the premises are selected from at least one of a room, a house, an apartment, a commercial building, and/or combination thereof. In an embodiment, the plurality of devices and infrastructure includes but not limited to an electric cabling, telephone or Ethernet cabling, a plumbing infrastructure/system, a general cabling infrastructure, a heating unit, a ventilation, an air-conditioning unit, an electrical unit, a furniture, an electronic unit etc.

The plurality of data records is curated during a plurality of phases such as a planning phase of the premises, a construction phase of the premises, an installation phase of the infrastructure and devices in the premises. The data is collected by utilizing various methods such as user inputs, digital blueprints of the premises and devices, video and sound recordings etc. Further, the collected data is processed for the presentation in a pre-defined state such as augmented reality (AR). The collection and curation of the data and information is a continuous process.

Then the method includes the step 104 of storing, managing and processing the curated data records in a database or in a cloud. Further, the method includes the step 106 of accessing, by one or more processors, the stored data records corresponding to the premises and the devices through a computing unit on receiving an input command from a user or the stored data may automatically activate through a plurality of sensors configured to the computing unit. In an embodiment, the computing unit includes but not limited to a computer, a smartphone, a tablet, a personal digital assistant (PDAs), mixed reality headsets, virtual reality headsets, and/or combination thereof.

In an embodiment, the present method utilizes various internationally recognized device identification methods to identify the various devices installed in the premises. Examples of the internationally recognized device identification methods include but not limited to Universal Product Code (UPC), International Standard Book Number (ISBN), and European Article Number (EAN). The Universal Product Code is a code printed on the retail product packaging to aid in identifying a particular item. It consists of a machine-readable barcode, which is a series of unique black bars, and a unique 12-digit number beneath it.

In another embodiment, the present method automatically identifies the installed device by utilizing a plurality of image recognition technologies such as Google Cloud Vision (developed by Google™), Amazon Rekognition (developed by Amazon™), Microsoft Azure (developed by Microsoft™) Apple Vision (developed by Apple™) Facebook Image-Recognition (developed by Facebook™), IBM Watson Visual Recognition (developed by IBM™), Cloudsight™, Clarifai™, Device Manufacturers image libraries and etc. The present system accesses these technologies by using authorized or licensed APIs provided by the respective organizations.

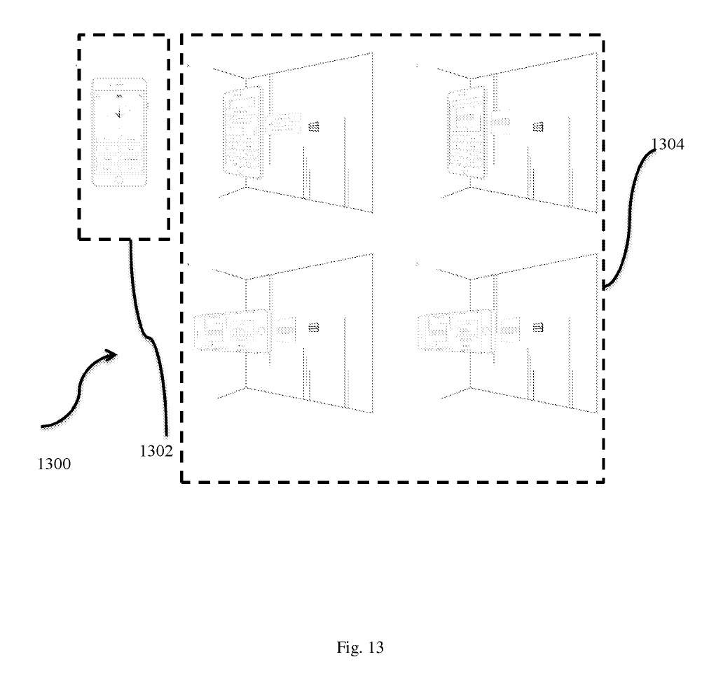

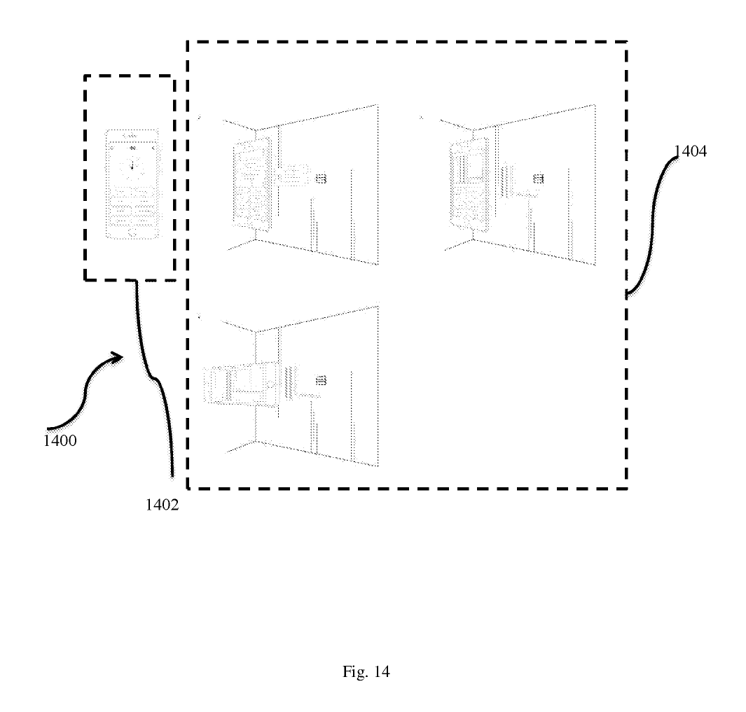

Furthermore, the method includes the step 108 of displaying, by one or more processors, the accessed data on receiving a pointing gesture from the user through the computing unit either towards the premises, various elements within the premises such as wall, ceilings, floors, doors etc. or the devices installed in the premises. The computing unit comprises an augmented reality mechanism to display the curated data records through a plurality of pre-defined user-interface states. In an embodiment, the plurality of user interface states includes a clock face/other image user-interface state, as shown in FIGS. 13-14, and an augmented reality user-interface state, as shown in FIGS. 13-14.

In an embodiment, the clock face/other image user-interface state displays a plurality of visual cues pertaining to the premises and the devices and further prevents an unintentional activation of the augmented reality user-interface state. The visual cue includes but not limited to a textual data record, a graphical data record, etc.

In an embodiment, the augmented reality user-interface state activates on receiving the pointing gesture at a wall, a floor, a ceiling, a door, a room, a device, a smart sensor, a building, or a furniture to display a corresponding curated data record.

Then the method includes the step 110 of enabling, by one or more processors, the user to add or remove data related to a plurality of additional devices which are originally not installed in the premises at the planning phase, construction phase, and installation phase of the devices in the premises. Further, the method includes the step 112 of enabling, by one or more processors, the user to wirelessly control a plurality of functions of the devices. The method then includes the step 114 of enabling, by one or more processors, the user to purchase a device, install a device, or purchase installation and maintenance services of the device or system in case the device or a system is damaged and requires a replacement or maintenance.

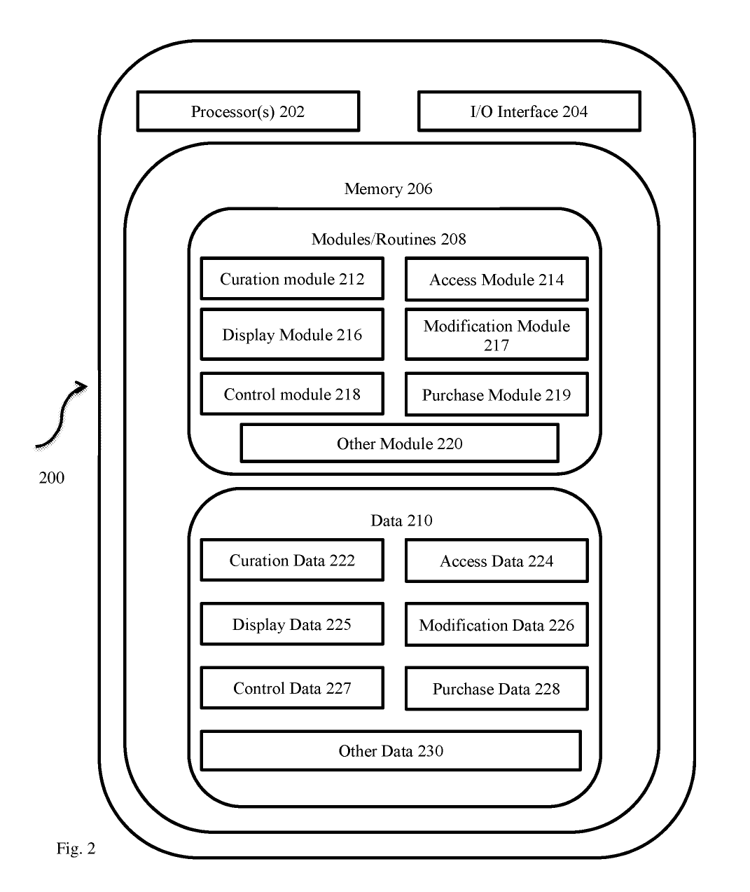

FIG. 2 represents a block diagram of the present system 200 for curating, accessing, and displaying a plurality of data records pertaining to premises, and a plurality of devices installed in the premises, in accordance with at least one embodiment. FIG. 2 is explained in conjunction with FIG. 1. In one embodiment, the system 200 may include at least one processor 202, an input/output (I/O) interface 204, and a memory 206. The processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 200 to interact with a user directly or through the computing units. Further, the I/O interface 204 may enable the system 200 to communicate with other computing devices, such as web servers and external data servers. The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 includes a curation module 212, an access module 214, a display module 216, a modification module 217, a control module 218, a purchase module 219, and other modules 220. The other modules 220 may include programs or coded instructions that supplement applications and functions of the system 200.

The data 210, amongst other things, serves as a repository for storing data processed, received, and generated by one or more of the modules 208. The data 210 may also include a curation data 222, an access data 224, a display data 225, a modification data 226, a control data 227, a purchase data 228, and other data 230. The other data 230 may include data generated as a result of the execution of one or more modules in the other module 220.

In one implementation, the curation module 212 curates a plurality of data records pertaining to premises and a plurality of devices installed in the premises. The plurality of data records is curated during a plurality of phases such as a planning phase of the premises, a construction phase of the premises, an installation phase of the devices in the premises.

The processor is configured to store the curated data records in a database or in a cloud. In one implementation, the access module 214 accesses the stored data records corresponding to the premises and the device by utilizing a computing unit on receiving an input command from a user. In one implementation, the display module 216 displays the accessed data on receiving a pointing gesture by the computing unit either towards the premises or the devices installed in the premises. The computing unit comprises an augmented reality mechanism to display the curated data records through a plurality of pre-defined user-interface states.

In one implementation, the modification module enables the user to add or remove data related to a plurality of additional devices which are originally not installed in the premises. In one implementation, the control module enables the user to wirelessly control a plurality of functions of the devices. In one embodiment, the wireless control mechanism can be accomplished by a plurality of methods. In the first method, once the software application automatically identifies the computing unit, the software application accesses the manufacturer of the device's built-in control functions/capabilities/methods. The control functions/capabilities/methods of the identified device are displayed in AR display mode by the application to the user.

In the second method, the software application uses the pre-programmed/configured control functions made by the installer or the user as a result of connections made between devices. For example, the devices of a multimedia system typically may be interconnected (e.g., by cabling, internet protocol, Bluetooth or infrared) in a wide variety of different manners. Once a user (e.g., an installer or end user) has determined all the connections/control functions that are required, or at least are desirable, between devices of a multimedia system, the application will gain access to the pre-programmed/configured control functions and give the end user the capability of controlling the multimedia system via AR (Augmented) display mode generated by the application. The software application gains access to the installer's or user's pre-programmed/configured control functions by using Internet protocol gateway components and licensed or authorized application interface protocols.

In one implementation, the purchase module to enable the user to purchase a device in case the device is damaged or requires a replacement. In an embodiment, the present system 200 and method can be utilized as a software application which uses Augmented Reality (AR) to display the various functions of the present installed device or system. If the user's computing unit has AR capabilities, the user can use the present system 200 to get the data and information about the house, room or installed infrastructures of the building.

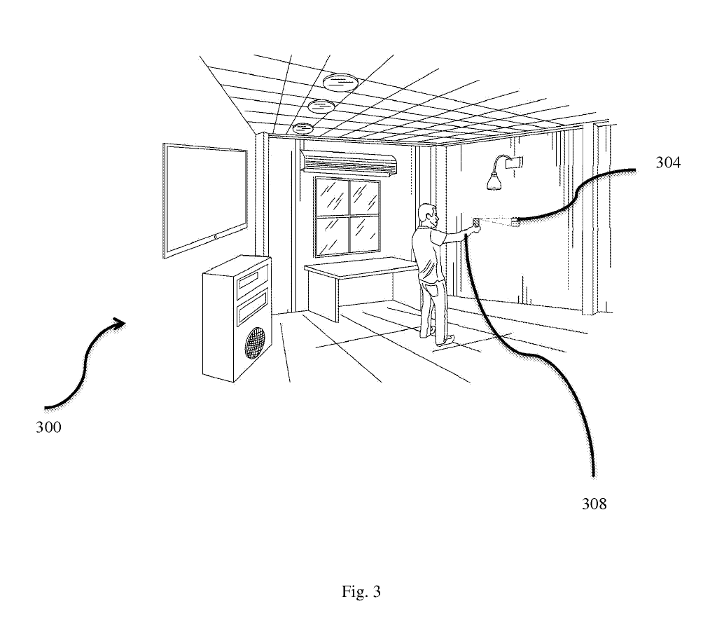

For example, if the user wants to see where the water pipes and electric cables of a building, house or room were installed behind a specific wall, floor or ceiling, all they have to do is, activate the software application installed on his/her computing unit, point their computing unit at a wall, floor or ceiling that he/she wishes to get information about and the user interface of the software application will change to display an AR (augmented reality) display of the water pipes and electric cables that were installed behind that specific wall, floor or ceiling (shown in FIG. 14). FIG. 3 illustrates an exemplary view 300 of a pointing gesture from the user through the computing unit 308 towards the device (smart sensors) 304 of the premises, in accordance with at least one embodiment.

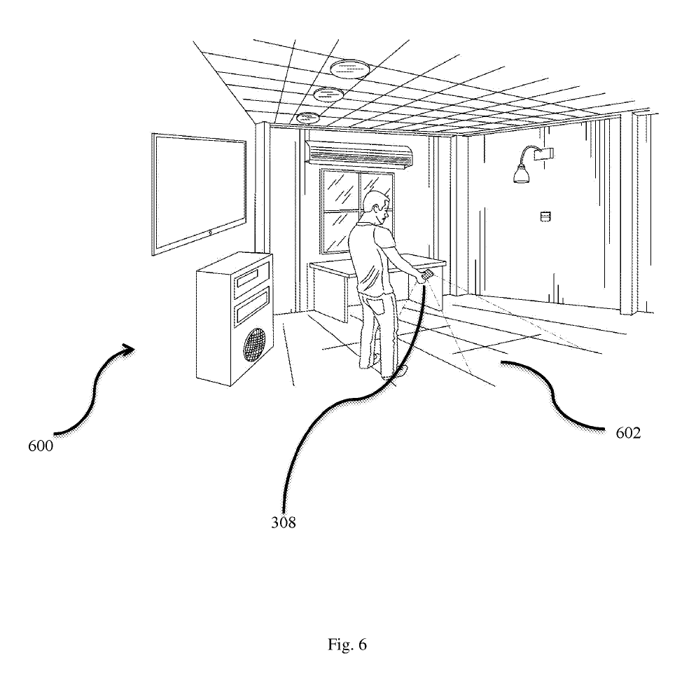

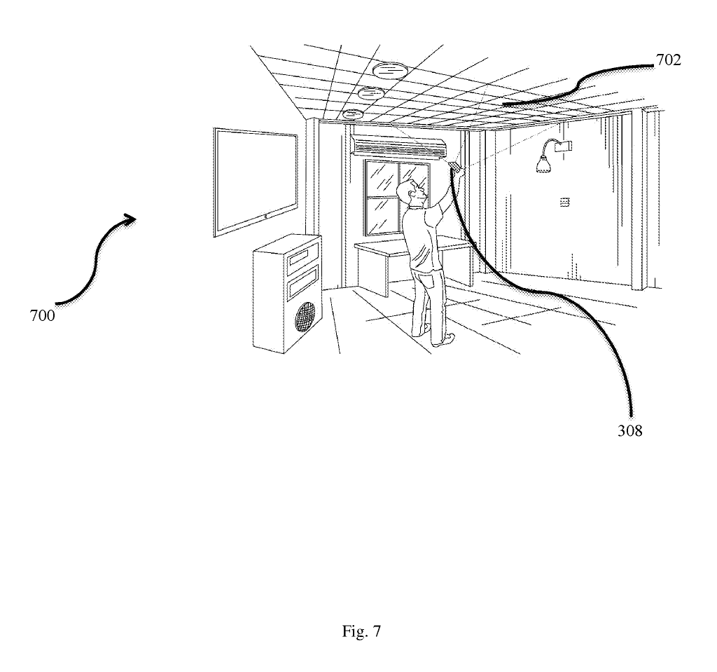

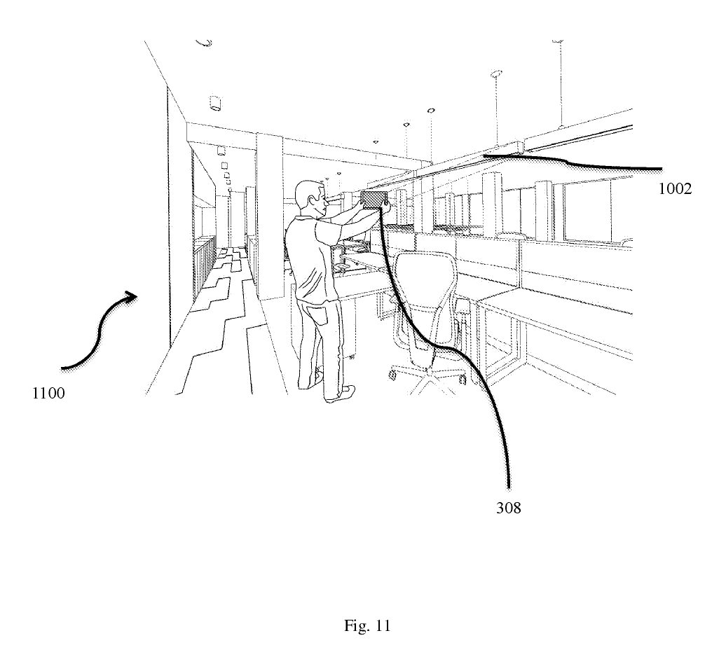

FIG. 6 illustrates an exemplary view 600 of a pointing gesture from the user through the computing unit towards the floor 602 of the premises, in accordance with at least one embodiment. FIG. 7 illustrates an exemplary view 700 of a pointing gesture from the user through the computing unit 308 towards the ceiling 702 of the premises, in accordance with at least one embodiment. FIG. 11 illustrates an exemplary view 1100 of a pointing gesture from the user through the computing unit 308 towards the lights 1102 installed in an office, in accordance with at least one embodiment.

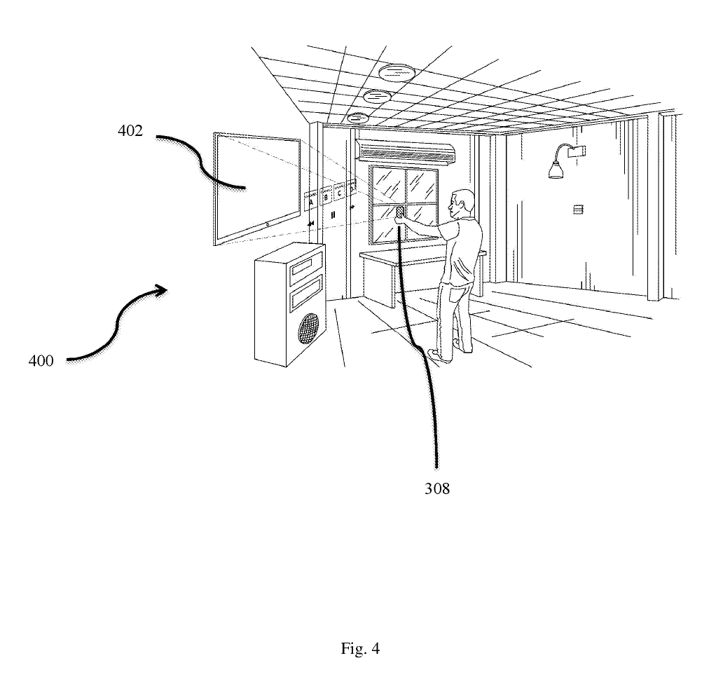

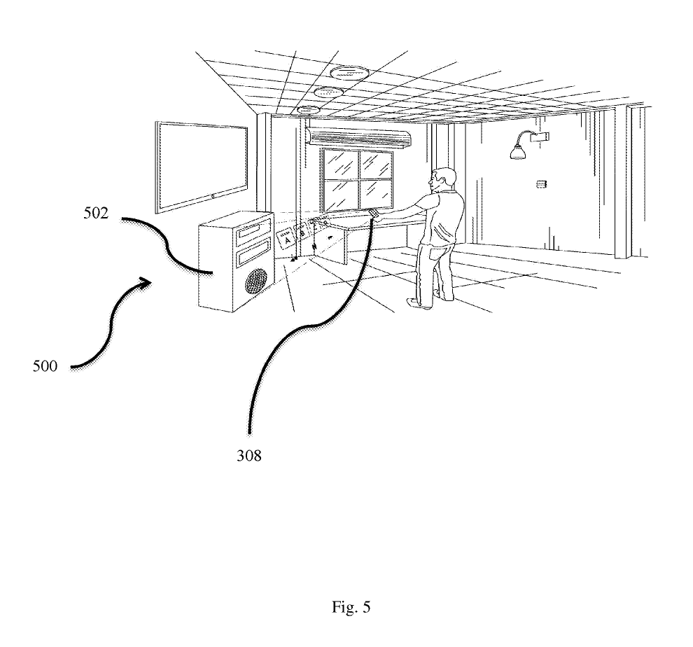

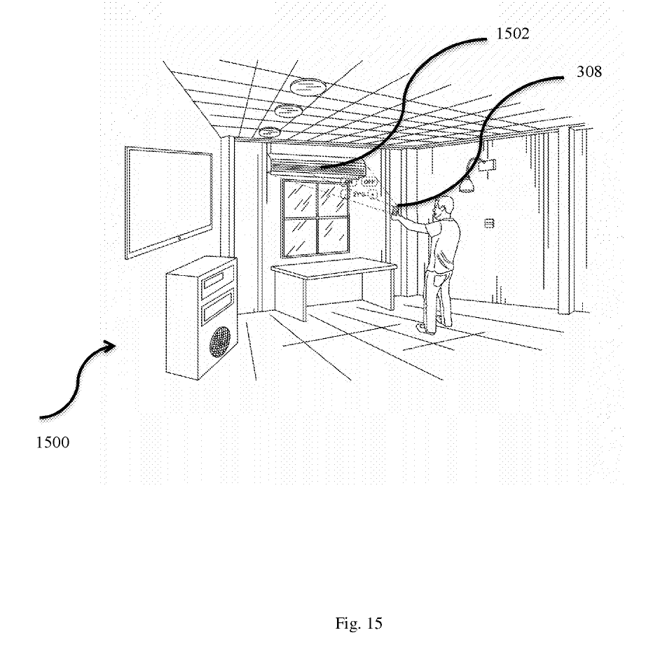

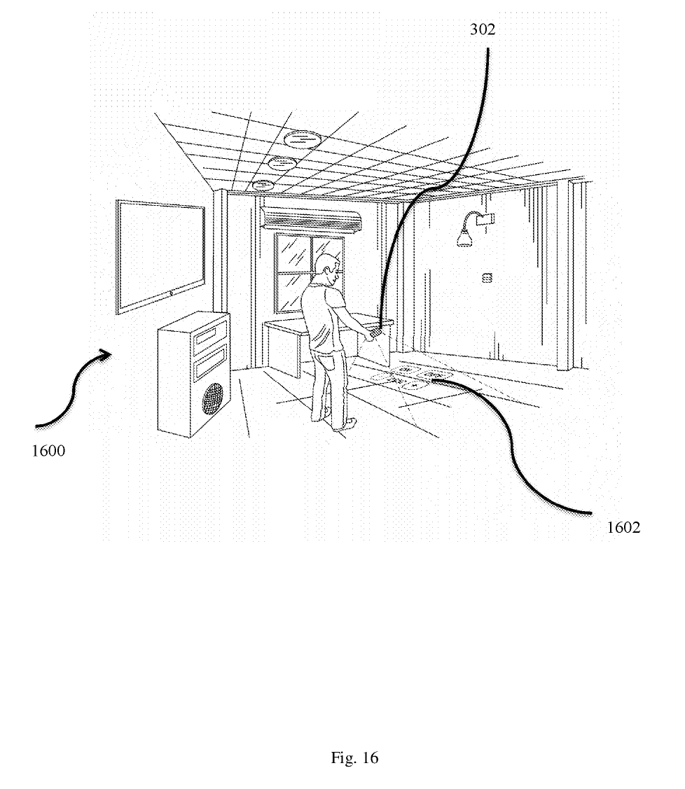

In another example, if the user points their computing unit at a particular device or smart sensor the software application would automatically identify the device and offer the user control function of that device (shown in FIG. 13). FIG. 4 illustrates an augmented reality control state 400 of the device such as a TV 402 on receiving a pointing gesture from the user through the computing unit 308, in accordance with at least one embodiment. FIG. 5 illustrates an augmented reality control state 500 of the device such as a stereo system 502 on receiving a pointing gesture from the user through the computing unit 308, in accordance with at least one embodiment. FIG. 15 illustrates an augmented reality control state and exemplary view 1500 of a pointing gesture from the user through the computing unit 308 to control an air-conditioning unit 1502 installed in the premises, in accordance with at least one embodiment. The present system 200 enables the user to control the air-conditioning (AC) unit 1502 by utilizing the augmented reality function. FIG. 16 illustrates an augmented reality control state and exemplary view 1600 of a pointing gesture from the user through the computing unit 308 to control a floor heating unit 1602 installed in the premises, in accordance with at least one embodiment. The present system 200 enables the user to control the floor heating unit 1602 via the augmented reality function. The software application automatically offers the option of controlling the floor heating unit 1602 on receiving the points gesture from the user through his/her computing unit 308 to the floor.

Further, if the user points his/her computing unit at a specific device, smart sensor, system, furniture or light, the system will automatically detect the device, smart sensor, system, furniture or light and proceed to provide information concerning device's specification, diagnostics results, installation date, guarantee information, suppliers and installer information in the event the device needs to be serviced, repaired or replaced. The user would have the ability to purchase the device, order maintenance or installation services from approved or various suppliers and installation companies. The present system enables the user to add or change installed devices, systems, suppliers and installation companies to the curated data.

FIG. 13 illustrates a plurality of pre-defined user-interface states 1300 such as a clock face/other image user-interface state 1302 and augmented reality user-interface state 1304, in accordance with at least one embodiment. FIG. 14 illustrates an exemplary view 1400 of plumbing and cabling networks 1402 and 1404 in a clock face/other image user-interface state and augmented reality user-interface state respectively, in accordance with at least one embodiment. The software application of the present system is configured with the computing unit of the user. This software application includes a plurality of user interface states (shown in FIGS. 13-14). A user interface state is a state in which the present software application responds in a predefined manner to a user input or action. The plurality of the user interface states on the computing unit includes a clock face/other image user-interface state 1302 and augmented reality user-interface state 1304.

In the clock face/other image user-interface state 1302, when the computing unit 308 is powered on and the software application is activated, the clock face/other image user-interface state 1302 ignores most, if not all, user inputs. Thus, the clock face/other image user-interface state 1302 does not initiate any action in response to the user input and/or the software application is prevented from performing a predefined set of functions. The clock face/other image user-interface state 1302 may be used to prevent unintentional activation of augmented reality user-interface state when the software application is launched.

When the software application is in clock face/other image state 1302, the AR (augmented reality) user-interface state 1304 displays function/capability may be said to be de-activated. In the clock face/image user-interface state, the application may respond to a limited set of user inputs, including input that corresponds to activating other functions that don't include the AR (augmented reality) user-interface state 1304. In other words, the clock face/other image user-interface state 1302 of the software application responds to the user input corresponding to attempts to activate other functions that do not involve the display of AR data and information (shown in FIG. 13).

The software application clock face/other image user-interface state 1302 on the tablet computer, smartphone, mixed reality headsets and virtual reality headsets may display one or more visual cue(s) of an activated AR function to the user. The visual cues may be textual, graphical or any combination thereof. The visual cues are displayed upon a particular occurring while in the application clock face/other image user-interface state 1302. The particular events that trigger the display of visual cues may include the tablet computer, smartphone, mixed reality headsets and virtual reality headsets image recognition capabilities, user's pointing gestures, geographical position and building and room identification sensors.

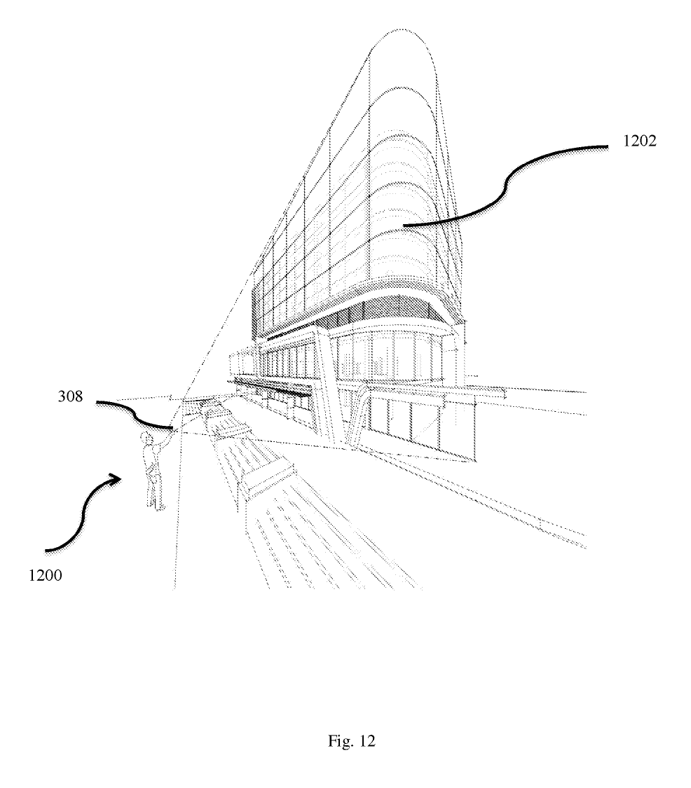

The AR (augmented reality) user-interface state 1304 includes a gesture of pointing the phone at a wall, floor, ceiling, door, room, device, smart sensor or furniture. The AR user-interface state 1304 is a predefined function activated when the user points their device at a wall, floor, ceiling, door, room, device, smart sensor, building, or furniture. FIG. 12 illustrates an exemplary view 1200 of a pointing gesture from the user through the computing unit 308 towards a building 1202, in accordance with at least one embodiment.

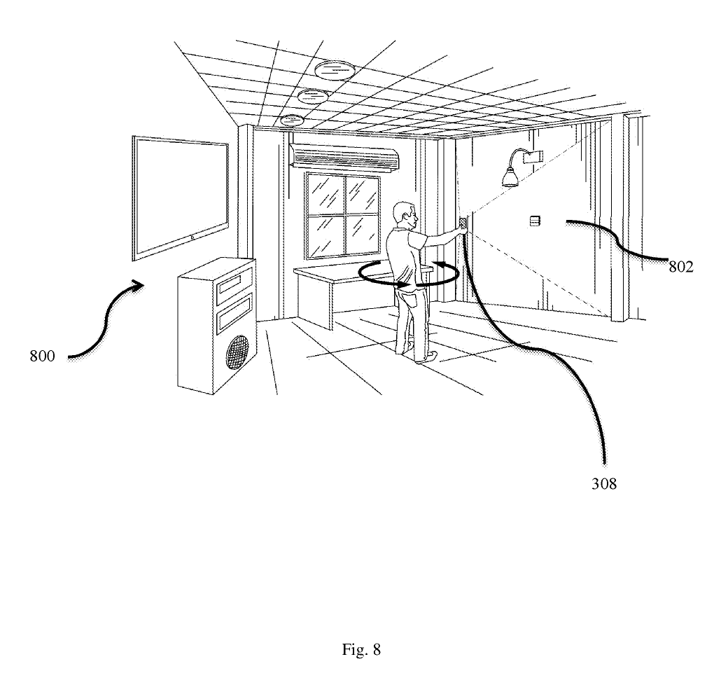

The gesture is a motion of the object/appendage pointing a tablet computer, smartphone, mixed reality headsets and virtual reality headsets device at an object or space. For example, the predefined gesture may include pointing a tablet computer, smartphone, mixed reality headsets and virtual reality headsets at a wall, ceiling, door, floor, building, device, smart sensor and making a 360-degree rotation (shown in FIG. 8). FIG. 8 illustrates an exemplary view 800 of a 360 degree pointing gesture from the user through the computing unit 308 towards the wall 802 of the premises or the devices installed in the premises, in accordance with at least one embodiment.

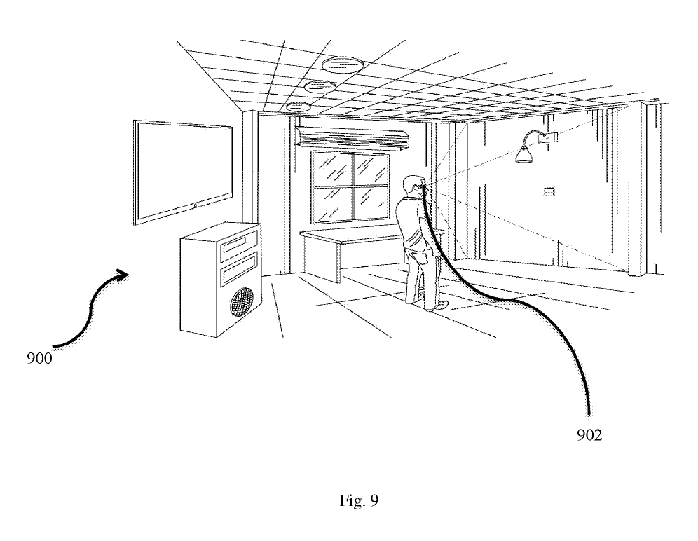

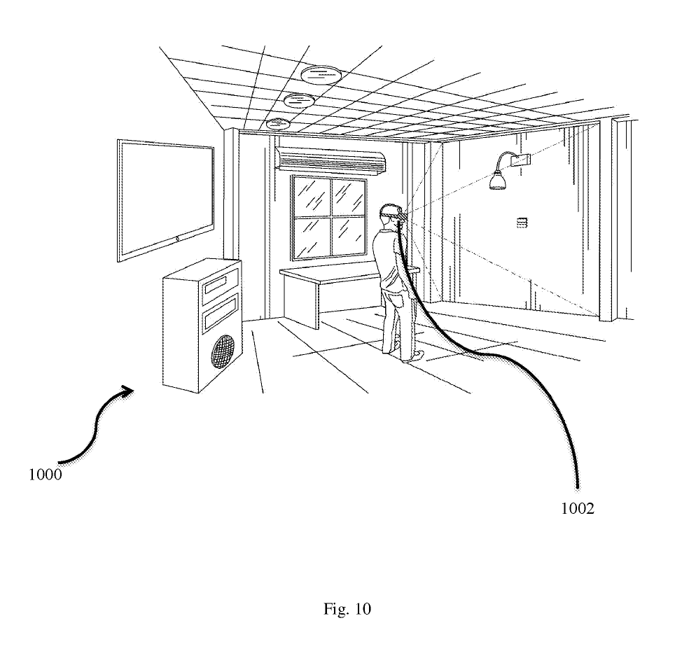

While the application is in clock face/other image user-interface state, the users may activate AR (augmented reality) user-interface state, i.e. point their mobile device as shown in FIGS. 3, 4, 5, 6, 7, and 11. The gesture of pointing a tablet computer, smartphone, mixed reality headsets and virtual reality headsets can be performed using one or two hands. However, it should be appreciated that the pointing gesture may be made using any suitable object or appendage, such as a tripod, selfie-stick, etc. FIG. 9 illustrates an exemplary view 900 of the user wearing a mixed reality headset 902, in accordance with at least one embodiment. FIG. 10 illustrates an exemplary view 1000 of the user wearing a virtual reality headset 1002, in accordance with at least one embodiment.

If the pointing gesture corresponds to a successful performance of the activate AR user-interface state i.e. the user performed the activated the AR user-interface state, the transitions of the user-interface state to the AR display mode depends on the element that they are pointing to such as premises and devices.

The software application begins the process of transitioning to the AR user-interface state activation state upon detection of any pointing gesture and aborts the transition as soon as the application determines that function needed does not correspond to the AR user-interface state.

When the software application is in clock face/other image user-interface state, the software application may display on user-interface objects corresponding to one or more functions of the software application and/or information that may be of interest to the user. The user-interface objects are objects that make up the user interface of the application and may include, without limitation, text, image, icons, soft keys (or “virtual buttons”), pull-down menus, radio buttons, check boxes, selectable lists, and so forth. The displayed user-interface objects may also include non-interactive objects that convey information or contribute to the look and feel of the user interface objects by making contact with the touch screen at one or more touch screen locations corresponding to the interactive objects with which she or he wishes to interact. The software application detects the contact and responds to the detected contact by performing the operation (s) corresponding to the interaction with the interactive object(s).

While the software application is in the clock face/other image user-interface state, the user may still make contact on a tablet computer, smartphone, mixed reality headsets and virtual reality headsets with touchscreen capabilities. However, the activated AR user-interface state is prevented from performing a predefined set of actions in response to detected contact until the devices detect the pointing gestures.

Thus, the present invention provides an integrated system which displays the installed infrastructure in the premise, provides a control over devices, allows to purchase replacement or upgrade devices, and enables the user to purchase maintenance and installation of services. The present invention provides a single unified platform to access, view, control and order goods and services related to premises and installed device. Further, the information that pertains to the suppliers of the devices, installers and maintenance service providers is curated by the present invention for the benefit of quality control of goods and services offered to the user.

While embodiments of the present invention have been illustrated and described, it will be clear that the present invention is not limited to these embodiments only. Numerous modifications, changes, variations, substitutions, and equivalents will be apparent to the person skilled in the art, without departing from the spirit and scope of the invention, as described in the claims.

1. A method implemented by one or more processors, the method comprising steps of:
curating, by one or more processors, a plurality of data records pertaining to a premise, and a plurality of devices installed in the premises, wherein the plurality of data records are curated during a plurality of phases selected from at least one of a planning phase of the premises, a construction phase of the premises, an installation phase of the devices in the premises, and/or combination thereof;
storing, by one or more processors, the curated data records in a database;
accessing, by one or more processors, the stored data records corresponding to the premises and the devices through a computing unit on receiving an input command from a user or the stored data may automatically activate through a plurality of sensors configured to the computing unit; and
displaying, by one or more processors, the accessed data on receiving a pointing gesture from the user through the computing unit either towards at least one of the premises, the devices installed in the premises, a plurality of elements within the premises such as wall, ceilings, floors, doors, and/or combination thereof, wherein the computing unit comprises an augmented reality mechanism to display the curated data records through a plurality of pre-defined user-interface states.

2. The method according to claim 1, further includes the step of enabling, by one or more processors, the user to add to or remove from data related to a plurality of additional devices which are originally not installed in the premises at the planning phase, construction phase, and installation phase of the devices in the premises.

3. The method according to claim 1, further includes the step of enabling, by one or more processors, the user to wirelessly control a plurality of functions of the devices.

4. The method according to claim 1, further includes the step of enabling, by one or more processors, the user to purchase a device, install a device, and purchase maintenance and installation services of the device or system in case the device or a system is damaged or requires a replacement.

5. The method according to claim 1, wherein the premises is selected from at least one of a room, a house, an apartment, a commercial building, and/or combination thereof.

6. The method according to claim 1, wherein the plurality of devices is selected from at least one of an electric cabling, telephone or Ethernet cabling, a plumbing infrastructure/system, a general cabling infrastructure, a heating unit, a ventilation, an air-conditioning unit, an electrical unit, a furniture, an electronic unit, and/or combination thereof.

7. The method according to claim 1, wherein the computing unit is selected from at least one of a computer, a smartphone, a tablet, mixed reality headsets, virtual reality headsets, and/or combination thereof.

8. The method according to claim 1, wherein the plurality of user interface states is configured with the computing unit comprising: a clock face/other image user-interface state and an augmented reality user-interface state.

9. The method according to claim 1, wherein the clock face user-interface state displays a plurality of visual cues pertaining to the premises and the devices, and further prevents an unintentional activation of the augmented reality user-interface state, wherein the visual cue is selected from at least one of a textual data record, a graphical data record and/or combination thereof.

10. The method according to claim 1, wherein the augmented reality user-interface state activates on receiving the pointing gesture at a wall, a floor, a ceiling, a door, a room, a device, a smart sensor, a building, or a furniture to display a corresponding curated data record.

11. A system for curating, accessing, and displaying a plurality of data records pertaining to premises, and a plurality of devices installed in the premises, the system comprising:
a processor; and a memory to store machine readable instructions that when executed by the processor causes the processor to:
curate a plurality of data records pertaining to a premise, and a plurality of devices installed in the premises through a curation module, wherein the plurality of data records are curated during a plurality of phases selected from at least one of a planning phase of the premises, a construction phase of the premises, an installation phase of the devices in the premises, and/or combination thereof;
store the curated data records in a database;
access the stored data records corresponding to the premises and the devices through an access module by utilizing a computing unit on receiving an input command from a user or the stored data may automatically activate through a plurality of sensors configured to the computing unit; and
display the accessed data through a display module on receiving a pointing gesture by the computing unit either towards at least one of the premises, the devices installed in the premises, a plurality of elements within the premises such as wall, ceilings, floors, doors, and/or combination thereof, wherein the computing unit comprises an augmented reality mechanism to display the curated data records through a plurality of pre-defined user-interface states.

12. The system according to claim 11, further includes a modification module to enable a user to add to or remove from data related to a plurality of additional devices which are originally not installed in the premises at the planning phase, construction phase, and installation phase of the devices in the premises.

13. The system according to claim 11, further includes a control module to enable the user to wirelessly control a plurality of functions of the devices.

14. The system according to claim 11, further includes a purchase module to enable the user to purchase a device, install a device, and purchase maintenance and installation services of the device or system in case the device or a system is damaged or requires a replacement.

15. The system according to claim 11, wherein the premises is selected from at least one of a room, a house, an apartment, a commercial building, and/or combination thereof.

16. The system according to claim 11, wherein the plurality of devices is selected from at least one of an electric cabling, telephone or Ethernet cabling, a plumbing infrastructure/system, a general cabling infrastructure, a heating unit, a ventilation, an air-conditioning unit, an electrical unit, a furniture, an electronic unit, and/or combination thereof.

17. The system according to claim 11, wherein the computing unit is selected from at least one of a computer, a smartphone, a tablet, mixed reality headsets, virtual reality headsets, and/or combination thereof.

18. The system according to claim 11, wherein the plurality of user interface states is configured with the computing unit comprising: a clock face/other image user-interface state and an augmented reality user-interface state.

19. The system according to claim 11, wherein the clock face/other image user-interface state displays a plurality of visual cues pertaining to the premises and the devices, and further prevents an unintentional activation of the augmented reality user-interface state, wherein the visual cue is selected from at least one of a textual data record, a graphical data record and/or combination thereof.

20. The system according to claim 11, wherein the augmented reality user-interface state activates on receiving the pointing gesture at a wall, a floor, a ceiling, a door, a room, a device, a smart sensor, a building, or a furniture to display a corresponding curated data record.
